(19) United States
(12) Patent Application Publication
(10) Pub. No.: US 2020/0239356 A1
(43) Pub. Date: Jul. 30, 2020

(54) CRISTOBALITE GLASS-CERAMICS

(71) Applicant: CORNING INCORPORATED, CORNING, NY (US)

(72) Inventor: Bruce Gardiner Aitken, Corning, NY (US)

(21) Appl. No.: 16/652,688

(22) PCT Filed: Oct. 4, 2018
(86) PCT No.: PCT/US18/54379

§ 371 Date: Apr. 1, 2020

Related U.S. Application Data
(60) Provisional application No. 62/569,175, filed on Oct. 6, 2017.

(51) Int. Cl. C03C 10/00

(52) U.S. Cl. CPC C03C 10/0009

(57) ABSTRACT

A glass-ceramic comprises cristobalite and is structurally stable. The glass-ceramic can have a composition comprising, on an oxide basis: phosphorous pentoxide, aluminum oxide, silicon dioxide, and approximately 3 mol % to approximately 16 mol % of a total amount of one or more modifier oxides such as MgO, CaO, ZnO, TiO₂, ZrO₂, and/or SnO₂, and the like. Most or all the crystallinity in the glass-ceramic can be cristobalite. The glass-ceramic can also have a glossy surface appearance and a relatively high coefficient of thermal expansion

### RELATED APPLICATIONS

This application claims the benefit of priority of U.S. Application No. 62/569,175 filed on Oct. 6, 2017, which is incorporated by reference herein in its entirety.

### BACKGROUND

Cristobalite is a high-temperature, crystalline polymorph of silica, meaning that it has the same chemical formula as quartz, SiO₂, but a distinct crystal structure. It is considered a refractory silica because it is stable at high temperatures (above 1300° C.) and has a melting point of 1713° C.

The cristobalite crystalline framework takes one of two forms depending on the temperature. At temperatures above 200° C., it is beta cristobalite and has a cubic structure. At temperatures below 200° C., it is alpha cristobalite and has a tetragonal structure. Alpha cristobalite is a paramorph of beta cristobalite and retains beta cristobalite's isometric shape.

While cristobalite has certain advantageous physical properties, it presents serious problems in a typical glass-ceramic production process. In general, the production of glass-ceramics involves the following steps: melting a mixture of raw glass materials usually including a nucleating agent, forming and cooling the glass below its transformation range, and crystallizing the glass article by an appropriate thermal treatment.

Crystallizing the glass is typically performed as a two-step process that includes heating the glass article to a temperature slightly higher than the transformation range to generate nuclei and then increasing the temperature to cause crystal growth on the nuclei. The crystal nucleation and crystal growth process is called ceramming. The glass-ceramic includes one or more crystalline phases and an amorphous phase.

The problem with cristobalite is that in the ceramming process it crystallizes as the beta form at high temperatures and then spontaneously undergoes a displacive transition or inversion to the alpha form as it cools below about 200° C. The transition involves a very large volume reduction which produces stresses that almost invariably cause cristobalite-rich glass-ceramics to shatter.

It would be desirable to produce cristobalite-rich materials such as cristobalite glass-ceramics that do not shatter when the material cools.

### SUMMARY

A number of embodiments are disclosed of a structurally stable glass-ceramic that comprises cristobalite. The glass-ceramic unexpectedly does not shatter as it cools during the ceramming process. In some embodiments, the glass-ceramic doesn't even exhibit any cracking when viewed with a scanning electron microscope. This makes it possible to make various components possessing the desirable properties of cristobalite but without its biggest drawback—its tendency to break during the alpha-beta inversion.

The glass-ceramic can have a constituent composition comprising, on an oxide basis, P₂O₅, Al₂O₃, SiO₂, and one or more modifier oxides such as magnesium oxide, zinc oxide, calcium oxide, tin dioxide, titanium dioxide, zirconium dioxide, and the like. In some embodiments, the glass-ceramic can include zinc, which gives it a self-glazing characteristic and yields a glossy surface. The glass-ceramic can be formed by ceramming an aluminophosphosilicate glass comprising the one or more modifier oxides.

The glass-ceramic can be rich in cristobalite. In some embodiments, at least 50 mol % or at least 50 wt % of the crystalline phase in the glass-ceramic is cristobalite. In other embodiments, at least 50 mol % or at least 50 wt % of the silica present in the glass-ceramic is in the form of cristobalite. In other embodiments, all or substantially all of the silica present in the glass-ceramic is in the form of cristobalite.

The glass-ceramic has a number of desirable and/or unusual properties compared to conventional ceramics. For example, the glass-ceramic can be considered a refractory ceramic, which is resistant to high temperatures. Also, the glass ceramic can have a relatively large CTE. It can also be relatively mechanically robust as well.

The glass-ceramic can be used in any of a number of different applications, especially those that leverage the desirable or unusual properties of the material. For example, the refractory properties of the glass-ceramic can make it suitable for use in situations where it is exposed to high temperatures. The high CTE of the glass-ceramic can make it compatible for use with other high expansion materials such as metals. It could also be used as a crystallizing frit for joining high expansion materials.

The Summary is provided to introduce a selection of concepts in a simplified form that are further described below in the Detailed Description. The Summary and the Background are not intended to identify key concepts or essential aspects of the disclosed subject matter, nor should they be used to constrict or limit the scope of the claims. For example, the scope of the claims should not be limited based on whether the recited subject matter includes any or all aspects noted in the Summary and/or addresses any of the issues noted in the Background.

### DRAWINGS

The preferred and other embodiments are disclosed in association with the accompanying drawings in which:

FIGS. 1-2 are charts showing the thermal expansion and coefficient of thermal expansion, respectively, for one embodiment of a structurally stable glass-ceramic comprising cristobalite.

FIG. 3 shows the X-ray diffraction pattern of another embodiment of a structurally stable glass-ceramic comprising cristobalite.

FIGS. 4-5 are scanning electron microscope images of two embodiments of a structurally stable glass ceramic comprising cristobalite.

### DETAILED DESCRIPTION

A number of embodiments of a glass-ceramic comprising cristobalite are disclosed. In general, the glass-ceramic is a monolithic piece of material that exhibits the unexpected behavior of not shattering or remaining structurally stable during the ceramming process. Most, if not all, of the embodiments of the glass-ceramic not only do not shatter during the ceramming process but also do not show any sign of cracking including microcracking. It should be appreciated that the glass-ceramic is not limited to only those embodiments without cracking. It also includes embodiments that exhibit some degree of cracking as long as the cracks do not cause it to shatter or break into more than one piece during the cooling process or make it so brittle, weak, and/or mechanically compromised that it is unsuitable for any practical application.

The reason the glass-ceramic does not shatter during the cooling process is not definitively known. One explanation is that the residual, amorphous glassy phase provides certain physical properties that keep the glass-ceramic from breaking apart during the cooling process. It's also possible that the glassy phase may interact with the crystalline phase in a specific way that prevents the glass-ceramic from shattering.

The glass ceramic can be made by heat treating a precursor glass having a variety of compositions. The precursor glass includes silicon dioxide (SiO₂) that crystallizes to form cristobalite during the heat treatment process. In some embodiments, the precursor glass is silica-rich and is capable of forming a dominant cristobalite phase in the glass-ceramic.

The amount of silicon dioxide in the precursor glass can vary widely depending on the desired physical properties of the glass-ceramic. In some embodiments, the precursor glass includes at least 55 mol % silicon dioxide, at least 60 mol % silicon dioxide, or at least 63 mol % silicon dioxide. In other embodiments, the precursor glass includes no more than 80 mol % silicon dioxide, no more than 75 mol % silicon dioxide, or no more than 72 mol % silicon dioxide. In other embodiments, the precursor glass includes 55 mol % to 80 mol % silicon dioxide, 60 mol % to 75 mol % silicon dioxide, or 63 mol % to 72 mol % silicon dioxide.

In terms of wt %, in some embodiments, the precursor glass can include at least 40 wt % silicon dioxide, at least 45 wt % silicon dioxide, or at least 48 wt % silicon dioxide. In other embodiments, the precursor glass includes no more than 73 wt % silicon dioxide, no more than 68 wt % silicon dioxide, or no more than 65 wt % silicon dioxide. In other embodiments, the precursor glass includes 40 wt % to 73 wt % silicon dioxide, 45 wt % to 68 wt % silicon dioxide, or 48 wt % to 65 wt % silicon dioxide.

One notable precursor glass is an aluminophosphosilicate glass comprising one or more modifier oxides. In general, this glass includes aluminum oxide (Al₂O₃), phosphorus pentoxide (P₂O₅), silicon dioxide (SiO₂), and one or more metal oxides (RₓO/RₓO₂ where R is a metal atom). Examples of compositions of this glass can be found in the '426 Patent referenced at the end of this document.

The aluminophosphosilicate glass can have any suitable composition. It can include silicon dioxide in any of the amounts given above. It can also include phosphorous pentoxide in any suitable amount. In some embodiments, the aluminophosphosilicate glass includes at least 3 mol % phosphorous pentoxide, at least 4 mol % phosphorous pentoxide, or at least 5 mol % phosphorous pentoxide. In other embodiments, the aluminophosphosilicate glass includes no more than 12 mol % phosphorous pentoxide, no more than 10 mol % phosphorous pentoxide, or no more than 8 mol % phosphorous pentoxide. In other embodiments, the aluminophosphosilicate glass includes 3 mol % to 12 mol % phosphorous pentoxide, 4 mol % to 10 mol % phosphorous pentoxide, or 5 mol % to 8 mol % phosphorous pentoxide.

In terms of wt %, in some embodiments, the aluminophosphosilicate glass can include at least 6 wt % phosphorous pentoxide, at least 8 wt % phosphorous pentoxide, or at least 10 wt % phosphorous pentoxide. In other embodiments, the aluminophosphosilicate glass includes no more than 24 wt % phosphorous pentoxide, no more than 20 wt % phosphorous pentoxide, or no more than 16 wt % phosphorous pentoxide. In other embodiments, the aluminophosphosilicate glass includes 6 wt % to 24 wt % phosphorous pentoxide, 8 wt % to 20 wt % phosphorous pentoxide, or 10 wt % to 16 wt % phosphorous pentoxide.

The aluminophosphosilicate glass can include aluminum oxide in any suitable amount. In some embodiments, the aluminophosphosilicate glass includes at least 5 mol % aluminum oxide, at least 7 mol % aluminum oxide, or at least 9 mol % aluminum oxide. In other embodiments, the aluminophosphosilicate glass includes no more than 30 mol % aluminum oxide, no more than 25 mol % aluminum oxide, or no more than 20 mol % aluminum oxide. In other embodiments, the aluminophosphosilicate glass includes 5 mol % to 30 mol % aluminum oxide, 7 mol % to 25 mol % aluminum oxide, or 9 mol % to 20 mol % aluminum oxide.

In terms of wt %, in some embodiments, the aluminophosphosilicate glass can include at least 7.5 wt % aluminum oxide, at least 10 wt % aluminum oxide, or at least 13 wt % aluminum oxide. In other embodiments, the aluminophosphosilicate glass includes no more than 40 wt % aluminum oxide, no more than 35 wt % aluminum oxide, or no more than 30 wt % aluminum oxide. In other embodiments, the aluminophosphosilicate glass includes 7.5 wt % to 40 wt % aluminum oxide, 10 wt % to 35 wt % aluminum oxide, or 13 wt % to 30 wt % aluminum oxide.

The aluminum phosphate glass can include any single modifier oxide or combination of modifier oxides in any suitable quantity. Notable examples of modifier oxides include magnesium oxide (MgO), calcium oxide (CaO), zinc oxide (ZnO), titanium dioxide (TiO₂), zirconium dioxide (ZrO₂), and/or tin dioxide (SnO₂). In some embodiments, the aluminophosphosilicate glass includes at least 3 mol % of the total amount of modifier oxides and/or no more than 16 mol % of the total amount of modifier oxides. In other embodiments, the aluminophosphosilicate glass includes at least 3.5 wt % of the total amount of modifier oxides and/or no more than 18 wt % of the total amount of modifier oxides.

It is generally desirable for the total amount of modifier oxides to be within these ranges. If the amount of modifier oxides is below this amount, then the glass crystallizes, if at all, via grain growth only on the surface rather than internally. Also, if the amount of modifier oxides is above this amount, then the glass has a tendency to opalize or partially devitrify due to the formation of metal phosphates such as Mg, Ca, and/or Zn phosphates, which is undesirable.

In one notable embodiment, the aluminophosphosilicate glass includes zinc oxide. The presence of zinc in the glass-ceramic is particularly attractive in view of its self-glazing characteristic, which yields a glossy surface.

The precursor glass is subjected to a heat treatment to facilitate crystal growth and formation of the glass-ceramic. In general, the glass-ceramic includes an amorphous glass phase and one or more crystalline phases. Also, it should be appreciated that the glass-ceramic can have the same composition as any of the precursor glasses described above since all compositions are given on an oxide basis as explained below.

The glass-ceramic can have any suitable amount and distribution of crystallization. For example, the glass-ceramic can include at least 50 vol % crystalline content or at least 50 wt % crystalline content. In many of the embodiments, the glass-ceramic usually has little or no indication of a residual glass halo, which indicates that it is highly crystalline. Also, the glass-ceramic can be uniformly crystallized or non-uniformly crystallized.

Cristobalite can form at least a majority of the crystalline content in the glass-ceramic. In some embodiments, cristobalite can be the sole crystalline phase in the glass-ceramic. In other embodiments, cristobalite can be present with other secondary crystalline phases such as gahnite spinel (ZnAl₂O₄) and magnesium phosphate. In these embodiments, cristobalite is typically present in much greater quantities than any other crystalline phase(s).

The quantity of silica in the glass-ceramic represents the upper limit of the amount of cristobalite that can be present in the glass-ceramic. In some embodiments, all of the silica in the glass-ceramic is present in the form of cristobalite. In other embodiments, only a portion of the silica is present in the form cristobalite. For example, at least 50 mol % of the silica can be cristobalite or at least 75 mol % of the silica can be cristobalite. In general, the other components in the glass-ceramic are either part of a secondary crystalline phase or are part of the amorphous phase.

The glass-ceramic can have a number of unusual and/or desirable physical properties. One such property is the coefficient of thermal expansion (CTE). Some embodiments of the glass-ceramic can have a CTE of at least 10 ppm/° C. Other embodiments of the glass-ceramic can have a CTE of at least 25 ppm/° C. The high CTE of the glass-ceramic can be matched with other materials that have a high expansion. For example, the glass-ceramic can be used as a substrate for a material that has a similarly high CTE such as some metals.

The glass-ceramic is also resistant to high temperatures. Cristobalite is stable up to 1700° C. However, because there is some residual glass in the glass-ceramic the actual upper use temperature might be lower than that, possibly in the range of 1400-1500° C. The combination of high temperature capability/resistance and a large CTE gives the glass-ceramic a unique combination of properties that can be tailored for certain applications such as substrates for other materials or as a frit.

The glass-ceramic can also be mechanically robust. It can be machined into various geometries such as plates and the like. It can also be machined into the regular slabs and chevron-notched samples required for the precise measurement of mechanical strength and fracture toughness.

The appearance of the glass-ceramic can vary depending on its composition. In general, the glass-ceramic is white, opaque, and not transparent. Most of the embodiments had a matte surface appearance with the notable exception of those embodiments that included Zn, which gave the glass-ceramic a glossy surface appearance.

The glass-ceramic can be made using any suitable process. The first step is to make the precursor glass. This includes melting the various components required to form the desired precursor glass composition to form a glass melt and then cooling the glass melt to form the precursor glass.

The next step is to subject the precursor glass to a heat treatment to form the glass-ceramic. This can include heating the precursor glass to a temperature (900-1000° C.) and for a duration (e.g., 1-3 hours) that is sufficient to facilitate nucleation in the precursor glass. In the case of the aluminophosphosilicate glass, it is believed that the phosphorous pentoxide is responsible for the internal nucleation of cristobalite observed in the glass-ceramics.

The nucleated glass is then heated to a higher temperature (1100-1300° C.) and for a sufficient duration (e.g., 1-3 hours) to facilitate crystal growth on the nuclei. The partially crystallized glass is then cooled to form the finished glass-ceramic.

It should be appreciated that the specifics of the method used to form the glass-ceramic can be changed in a number of ways. For example, other ceram schedules can be used to facilitate crystal formation in the glass.

### EXAMPLES

The following examples are provided to further illustrate the disclosed subject matter. They should not be used to constrict or limit the scope of the claims in any way.

### Example 1

A number of samples of glass-ceramics were cerammed from aluminophosphosilicate glass having the compositions, on an oxide basis, shown in Table 1 and Table 2 below. The glass was silica-rich and included varying amounts of P₂O₅, Al₂O₃, SiO₂, and one or more of the following modifier oxides: MgO, CaO, ZnO, TiO₂, ZrO₂, and/or SnO₂.

The process used to produce each sample was the same. The aluminophosphosilicate glass was heated in a furnace to 975° C. for 2 hours to facilitate nucleation (P₂O₅ was believed to be responsible for the internal nucleation) and then heated to 1200° C. for 2 hours to facilitate crystal growth on the nuclei. The furnace was turned off and the partially crystallized glass was allowed to cool to ambient temperature. All of the samples cooled to ambient temperature without breaking.

TABLE 1
Structurally Stable Cristobalite Glass-Ceramic Compositions (on an oxide basis)

| | MgO | | ZnO | | CaO | | SnO₂ | | P₂O₅ | | Al₂O₃ | | SiO₂ | |
|---|---|---|---|---|---|---|---|---|---|---|---|---|---|---|
| Sample | mol % | wt % | mol % | wt % | mol % | wt % | mol % | wt % | mol % | wt % | mol % | wt % | mol % | wt % |
| A-1 | 12.5 | 7.41 | — | — | — | — | — | — | 7.5 | 15.7 | 10 | 15 | 70 | 61.8 |
| A-2 | 11.25 | 6.59 | — | — | — | — | — | — | 7.5 | 15.5 | 11.25 | 16.7 | 70 | 61.2 |
| A-3 | 10 | 5.8 | — | — | — | — | — | — | 7.5 | 15.3 | 12.5 | 18.3 | 70 | 60.5 |
| A-4 | 7.5 | 4.26 | — | — | — | — | — | — | 7.5 | 15 | 15 | 21.5 | 70 | 59.2 |
| A-5 | 5 | 2.87 | — | — | 5 | 3.99 | — | — | 7.5 | 15.2 | 12.5. | 18.1 | 70 | 59.8 |
| A-6 | 15 | 8.83 | — | — | — | — | — | — | 7.5 | 15.5 | 12.5 | 18.6 | 65 | 57 |
| A-7 | — | — | 12.5 | 13.9 | — | — | — | — | 7.5 | 14.6 | 10 | 13.9 | 70 | 57.5 |
| A-8 | — | — | 11.25 | 12.5 | — | — | — | — | 7.5 | 14.5 | 11.25 | 15.6 | 70 | 57.3 |
| A-9 | — | — | 10 | 11.1 | — | — | — | — | 7.5 | 14.5 | 12.5 | 17.3 | 70 | 57.1 |
| A-10 | — | — | 7.5 | 8.24 | — | — | — | — | 7.5 | 14.4 | 15 | 20.6 | 70 | 56.7 |
| A-11 | 11 | 6.43 | — | — | — | — | 0.1 | 0.22 | 7.5 | 15.4 | 11.5 | 17 | 69.9 | 60.9 |
| A-12 | 3.5 | 1.94 | 4 | 4.47 | — | — | 0.1 | 0.21 | 7.5 | 14.6 | 15 | 21 | 69.9 | 57.7 |
| A-13 | 12.5 | 7.32 | — | — | — | — | — | — | 7.5 | 15.5 | 12 | 17.8 | 68 | 59.3 |
| A-14 | 11 | 6.47 | — | — | — | — | — | — | 6.5 | 13.5 | 12.5 | 18.6 | 70 | 61.4 |
| A-15 | — | — | 10 | 10.9 | — | — | — | — | 7.5 | 14.3 | 14.5 | 19.9 | 68 | 54.9 |
| A-16 | — | — | 10 | 11.1 | — | — | — | — | 6.5 | 12.6 | 13.5 | 18.8 | 70 | 57.4 |

TABLE 2
Structurally Stable Cristobalite Glass-Ceramic Compositions (on an oxide basis)

| | TiO₂ | | ZrO₂ | | CaO | | SnO₂ | | P₂O₅ | | Al₂O₃ | | SiO₂ | |
|---|---|---|---|---|---|---|---|---|---|---|---|---|---|---|
| Sample | mol % | wt % | mol % | wt % | mol % | wt % | mol % | wt % | mol % | wt % | mol % | wt % | mol % | wt % |
| A-17 | 4 | 4.27 | — | — | — | — | — | — | 7.5 | 14.2 | 18.5 | 25.2 | 70 | 56.2 |
| A-18 | 6 | 6.45 | — | — | — | — | — | — | 7.5 | 14.3 | 16.5 | 22.6 | 70 | 56.6 |
| A-19 | — | — | 4 | 6.44 | — | — | — | — | 7.5 | 13.9 | 18.5 | 24.7 | 70 | 55.0 |
| A-20 | — | — | 6 | 9.61 | — | — | — | — | 7.5 | 13.8 | 16.5 | 21.9 | 70 | 54.7 |
| A-21 | — | — | — | — | — | — | 4 | 7.77 | 7.5 | 13.7 | 18.5 | 24.3 | 70 | 54.2 |
| A-22 | 10 | 10.8 | — | — | — | — | 1 | 2.04 | 7.5 | 14.4 | 12.5 | 15.9 | 70 | 56.9 |
| A-23 | — | — | — | — | 7.5 | 5.82 | — | — | 7.5 | 14.7 | 15 | 21.2 | 70 | 58.2 |

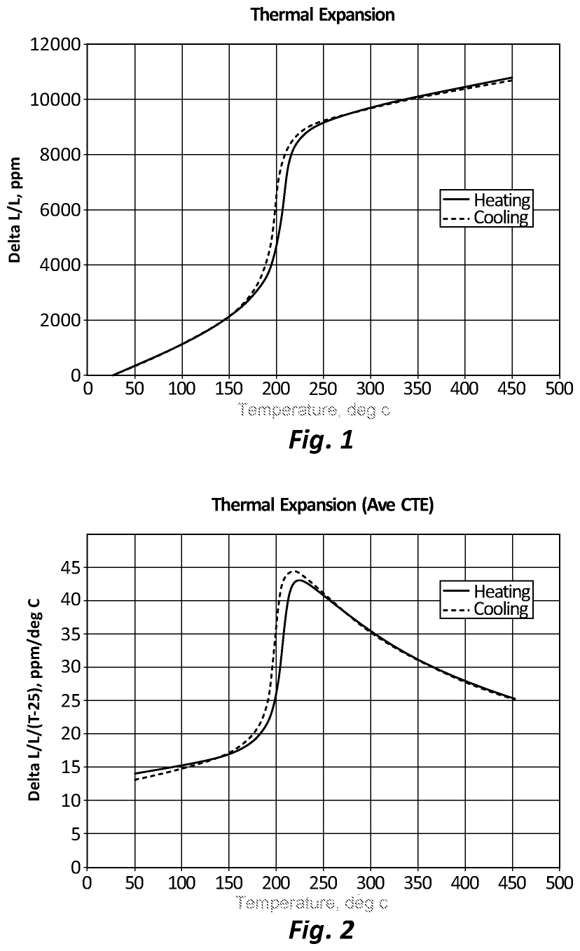

The samples exhibited a thermal expansion/contraction on heating/cooling through 200° C. that was indicative of the transition between the higher temperature beta-cristobalite phase and the lower temperature alpha-cristobalite phase. FIGS. 1-2 show the thermal expansion and the coefficient of thermal expansion, respectively, for sample A-3. They clearly show the large change in expansion around 200° C.

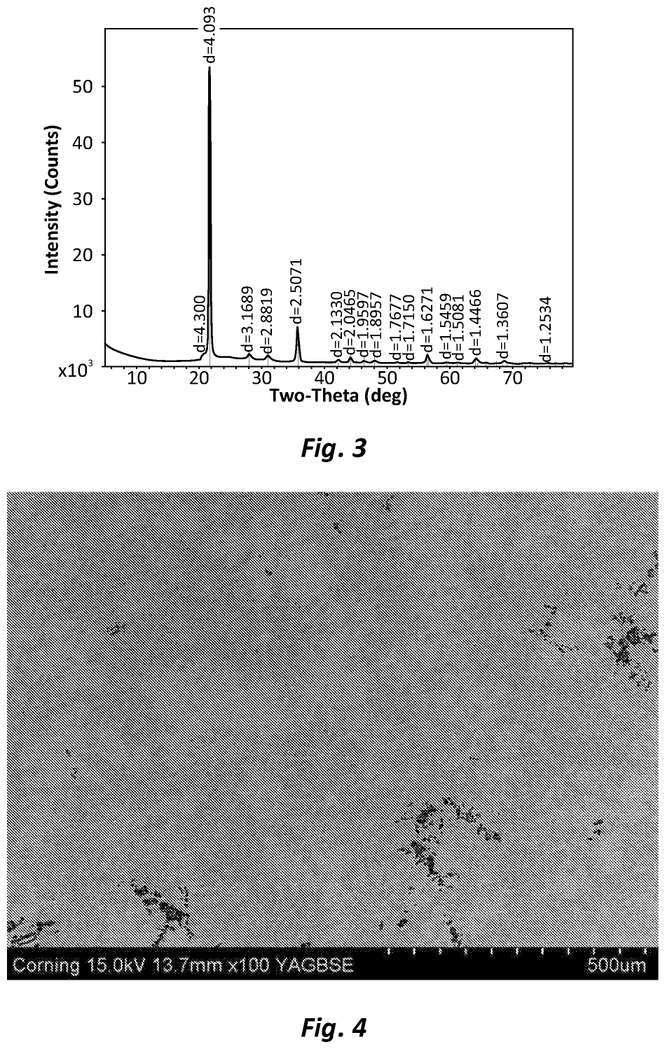

The presence of cristobalite was confirmed by analyzing a number of the samples using X-ray diffraction. FIG. 3 shows the X-ray diffraction pattern of sample A-23, which shows that cristobalite is the sole crystalline phase.

The properties of a number of samples were analyzed and reported in Table 3 below. One notable property was the mechanical robustness of the samples. They were sufficiently robust to be machined into rectangular slabs and into chevron-notched samples for precise measurement of their mechanical strength and fracture toughness. Also, the strength and toughness tests show that these materials are unusually strong and tough given their cristobalite content. Although not all of the properties of all of the samples were measured, it is believed that the properties would be at least similar in nature due to the similar look and feel of the samples.

TABLE 3
Structurally Stable Cristobalite Glass-Ceramic Properties

| | | | | | Ring-on-ring | | Fracture | | |
|---|---|---|---|---|---|---|---|---|---|
| | Temp¹ | | CTE² | | Strength³ | | Toughness⁴ | | |
| | (° C.) | | (ppm/° C.) | | (MPa) | | (MPa · √m) | | |
| Sample | Strain | Anneal | Before | After | Ave | Max | Ave | Max | Appearance⁵ |
| A-1 | — | — | — | — | — | — | — | — | matte; vfgr |
| A-2 | — | — | 2.14 | — | — | — | — | — | matte; vfgr |
| A-3 | — | — | 2.01 | 35.2 | 60.1 | 63.6 | 1.59 | 1.73 | matte; vfgr |
| A-4 | — | — | 1.75 | — | — | — | — | — | matte; cgr |
| A-5 | — | — | — | — | — | — | — | — | matte; vfgr |
| A-6 | — | — | 2.71 | — | — | — | — | — | matte; vfgr |
| A-7 | — | — | — | — | — | — | — | — | glossy; m-cgr |
| A-8 | — | — | 1.81 | — | — | — | — | — | glossy; mgr |
| A-9 | — | — | 1.67 | — | — | — | — | — | glossy; cgr |
| A-10 | — | — | 1.49 | 33.4 | 72.9 | 81.9 | 0.82 | 0.83 | glossy; vfgr |
| A-11 | — | — | 2.19 | — | — | — | — | — | matte; vfgr |
| A-12 | — | — | 1.63 | — | — | — | — | — | glossy; vfgr |
| A-13 | — | — | — | — | — | — | — | — | matte; m-cgr |
| A-14 | — | — | — | — | — | — | — | — | matte; vfgr |
| A-15 | — | — | — | — | — | — | — | — | glossy; vfgr |
| A-16 | — | — | — | — | — | — | — | — | glossy; fgr |
| A-17 | 836 | 897 | 1.13 | 17.4 | — | — | — | — | matte; vfgr |
| A-18 | 839 | 909 | 1.00 | 14.7 | — | — | — | — | matte; vfgr |
| A-19 | 869 | 923 | 1.28 | 14.5 | — | — | — | — | translucent; xfgr |
| A-20 | 906 | 967 | 1.42 | 17.6 | — | — | — | — | translucent; xfgr |
| A-21 | 800 | 857 | 1.43 | — | — | — | — | — | matte; vfgr |
| A-22 | — | — | 1.14 | 18.3 | — | — | — | — | matte; vfgr |
| A-23 | 811 | 865 | 2.60 | — | — | — | — | — | matte; mgr |

¹Temperature of the strain and anneal points of the glass before heat treatment.
²Coefficient of thermal expansion before and after heat treatment (average value from 25° C. to 300° C.); ASTME228.
³Ring-on-ring strength measurement after heat treatment; ASTM C1499.
⁴Fracture toughness after heat treatment (chevron notch test); ASTM E1304.
⁵xfgr = extra fine grain; vfgr = very fine grain; fgr = fine grain; mgr = medium grain; m-cgr = medium-coarse grain* car = coarse grain

Another notable property of the samples is their relatively high CTEs. The samples that were tested tended to have significantly higher CTEs than other glass-ceramics. It is believed that the samples that were not tested also have similarly high CTEs. Notably, the glass ceramics containing Mg and Zn had CTEs in the mid-30s, while the glass ceramics including Ti or Zr had CTEs in the mid to upper teens. Their high CTEs may make the glass-ceramics particularly suitable for use with other materials that have high CTEs such as metals and the like.

The appearance at the samples also varied. Overall, the samples produced glass-ceramics that were white, opaque, and not transparent. The samples that contained zinc had a self-glazing characteristic that caused them to form a desirable glossy outer surface. The samples that contained zirconium were translucent but not transparent. The other samples tended to have a matte surface appearance.

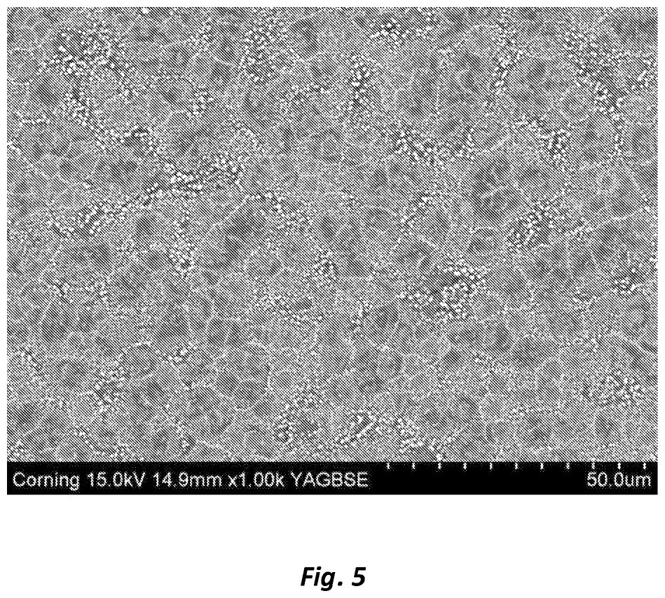

Some of the samples were analyzed using a scanning electron microscope (SEM). FIGS. 4-5 show SEM images of samples A-3 and A-10, respectively. The image of sample A-3 shows that it includes approximately 50 μm spherulites of skeletal cristobalite with no sign of micro-cracking. The image of sample A-10 shows that it includes a primary crystalline phase of approximately 5 μm cristobalite spherulites and secondary crystalline phase of intergranular gahnite spinel (ZnAl₂O₄). It also shows no signs of micro-cracking.

The results of the tests were surprising on a number of levels. At one level, it was surprising that the samples cooled to ambient temperature without shattering, which is the typical behavior of conventional glass-ceramics having a predominantly cristobalite crystalline phase. At another level, it was surprising that the samples cooled to ambient temperature and went through the beta-alpha transition without forming any micro-cracking. They were also surprisingly mechanically robust despite including a dominant cristobalite crystalline phase. At yet another level, it was especially surprising that the samples comprising zinc had a self-glazing characteristic which yielded a glossy surface appearance.

### Example 2

A glass-ceramic sample was cerammed from aluminophosphosilicate glass having the composition, on an oxide basis, shown in Table 4 below. The sample was prepared using the same procedure described in Example 1. The sample shattered as it cooled and the cristobalite transitioned from the beta form to the alpha form. Most of the properties of the sample were not measured because the sample shattered. However, the sample had a matte appearance and very fine grain size.

TABLE 4
Structurally Unstable Cristobalite Glass-Ceramic Composition

| | TiO₂ | | ZrO₂ | | CaO | | SnO₂ | | P₂O₅ | | Al₂O₃ | | SiO₂ | |
|---|---|---|---|---|---|---|---|---|---|---|---|---|---|---|
| Sample | mol % | wt % | mol % | wt % | mol % | wt % | mol % | wt % | mol % | wt % | mol % | wt % | mol % | wt % |
| B-1 | 2 | 2.12 | — | — | — | — | — | — | 7.5 | 14.2 | 20.5 | 27.8 | 70 | 55.9 |

Although not wishing to be bound by theory, one possible reason the sample did not work was that there was insufficient residual glass to relieve the stresses occasioned by the beta-alpha cristobalite transition. Residual glass concentration may perhaps be increased by increasing the content of the modifier oxide(s) (RO/RO₂) in the precursor aluminophosphosilicate glass because the modifier oxide(s) does not partition into the cristobalite crystal phase and therefore resides in the residual glassy phase after ceramming.

### ILLUSTRATIVE EMBODIMENTS

Reference is made in the following to several illustrative embodiments of the disclosed subject matter. The following embodiments illustrate only a few selected embodiments that may include one or more of the various features, characteristics, and advantages of the disclosed subject matter. Accordingly, the following embodiments should not be considered as being comprehensive of all the possible embodiments.

According to one embodiment, a glass-ceramic has a composition comprising, on an oxide basis: P₂O₅, Al₂O₃, SiO₂, and approximately 3 mol % to approximately 16 mol % of a total amount of MgO, CaO, ZnO, TiO2, ZrO2, and/or SnO2, wherein the glass-ceramic comprises cristobalite and is structurally stable. The composition can comprise, on an oxide basis: ZnO. The glass-ceramic can comprise gahnite. The composition can comprise, on an oxide basis: approximately 3 mol % to approximately 12 mol % of P₂O₅, approximately 7 mol % to approximately 30 mol % of Al₂O₃, and approximately 55 mol % to approximately 80 mol % of SiO₂. The composition can comprise, on an oxide basis: approximately 5 mol % to approximately 8 mol % of P₂O₅, approximately 9 mol % to approximately 20 mol % of Al₂O₃, and approximately 63 mol % to approximately 72 mol % of SiO₂. At least 50 vol % or 50 wt % of the glass-ceramic can be crystalline. At least a majority of the crystallinity in the glass-ceramic can be cristobalite. At least 35 wt % of the glass-ceramic can be cristobalite. The glass-ceramic can comprise alpha-cristobalite. The glass-ceramic can have a coefficient of thermal expansion of at least 10 ppm/° C. or at least 25 ppm/° C. The glass-ceramic can show no sign of crack formation. The glass-ceramic can have a glossy surface appearance.

In another embodiment, a method for making a glass-ceramic comprises: heating an aluminophosphosilicate glass to facilitate nucleation and form a nucleated glass, the aluminosilicate glass comprising, on an oxide basis: approximately 3 mol % to approximately 16 mol % of a total amount of MgO, CaO, ZnO, TiO2, ZrO2, and/or SnO2; heating the nucleated glass to a higher temperature to facilitate crystallization and form a partially crystallized glass; and cooling the partially crystallized glass to room temperature without breaking the partially crystallized glass to form the glass-ceramic. The method can also comprise: melting a glass composition having the same composition as the aluminophosphosilicate glass to form a glass melt; and cooling the glass melt to form the aluminophosphosilicate glass. The aluminophosphosilicate glass can comprise, on an oxide basis: approximately 3 mol % to approximately 12 mol % of P₂O₅, approximately 7 mol % to approximately 30 mol % of Al₂O₃, and approximately 55 mol % to approximately 80 mol % of SiO₂.

In another embodiment, a glass-ceramic can be formed from an aluminophosphosilicate glass comprising, on an oxide basis: approximately 3 mol % to approximately 20 mol % of a total amount of MgO, CaO, ZnO, TiO2, ZrO2, and/or SnO2, wherein the glass-ceramic comprises cristobalite and is structurally stable. The aluminophosphosilicate glass can comprise, on an oxide basis: approximately 3 mol % to approximately 12 mol % of P₂O₅, approximately 7 mol % to approximately 30 mol % of Al₂O₃, and approximately 55 mol % to approximately 80 mol % of SiO₂. The aluminophosphosilicate glass can comprise, on an oxide basis: ZnO.

### Terminology and Interpretative Norms

The term “structurally stable” refers to the ability of a glass-ceramic to cool to room temperature without breaking apart. The terms “glass” and “glass composition” encompass both glass materials and glass-ceramic materials, as both classes of materials are commonly understood. The composition of the glass or glass-ceramic is reported in mol % or wt % on an individual oxide basis even though the specific elements may not be present in their pure or individual oxide forms but rather chemically bonded together or physically held together within the glass matrix. In this regard, the glass-cermaic materials may be reported by their “constituent composition” referring to the composition of the precursor glass.

Any methods described in the claims or specification should not be interpreted to require the steps to be performed in a specific order unless stated otherwise. Also, the methods should be interpreted to provide support to perform the recited steps in any order unless stated otherwise.

Spatial or directional terms, such as “left,” “right,” “front,” “back,” and the like, relate to the subject matter as it is shown in the drawings. However, it is to be understood that the described subject matter may assume various alternative orientations and, accordingly, such terms are not to be considered as limiting.

Articles such as “the,” “a,” and “an” can connote the singular or plural. Also, the word “or” when used without a preceding “either” (or other similar language indicating that “or” is unequivocally meant to be exclusive—e.g., only one of x or y, etc.) shall be interpreted to be inclusive (e.g., “x or y” means one or both x or y).

The term “and/or” shall also be interpreted to be inclusive (e.g., “x and/or y” means one or both x or y). In situations where “and/or” or “or” are used as a conjunction for a group of three or more items, the group should be interpreted to include one item alone, all the items together, or any combination or number of the items.

The terms have, having, include, and including should be interpreted to be synonymous with the terms comprise and comprising. The use of these terms should also be understood as disclosing and providing support for narrower alternative embodiments where these terms are replaced by “consisting” or “consisting essentially of.”

Unless otherwise indicated, all numbers or expressions, such as those expressing dimensions, physical characteristics, and the like, used in the specification (other than the claims) are understood to be modified in all instances by the term “approximately.” At the very least, and not as an attempt to limit the application of the doctrine of equivalents to the claims, each numerical parameter recited in the specification or claims which is modified by the term “approximately” should be construed in light of the number of recited significant digits and by applying ordinary rounding techniques.

All disclosed ranges are to be understood to encompass and provide support for claims that recite any and all subranges or any and all individual values subsumed by each range. For example, a stated range of 1 to 10 should be considered to include and provide support for claims that recite any and all subranges or individual values that are between and/or inclusive of the minimum value of 1 and the maximum value of 10; that is, all subranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth).

All disclosed numerical values are to be understood as being variable from 0-100% in either direction and thus provide support for claims that recite such values or any and all ranges or subranges that can be formed by such values. For example, a stated numerical value of 8 should be understood to vary from 0 to 16 (100% in either direction) and provide support for claims that recite the range itself (e.g., 0 to 16), any subrange within the range (e.g., 2 to 12.5) or any individual value within that range (e.g., 15.2).

The drawings shall be interpreted as illustrating one or more embodiments that are drawn to scale and/or one or more embodiments that are not drawn to scale. This means the drawings can be interpreted, for example, as showing: (a) everything drawn to scale, (b) nothing drawn to scale, or (c) one or more features drawn to scale and one or more features not drawn to scale. Accordingly, the drawings can serve to provide support to recite the sizes, proportions, and/or other dimensions of any of the illustrated features either alone or relative to each other. Furthermore, all such sizes, proportions, and/or other dimensions are to be understood as being variable from 0-100% in either direction and thus provide support for claims that recite such values or any and all ranges or subranges that can be formed by such values.

The terms recited in the claims should be given their ordinary and customary meaning as determined by reference to relevant entries in widely used general dictionaries and/or relevant technical dictionaries, commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries, etc.) subject only to the following exceptions: (a) if a term is used in a manner that is more expansive than its ordinary and customary meaning, the term should be given its ordinary and customary meaning plus the additional expansive meaning, or (b) if a term has been explicitly defined to have a different meaning by reciting the term followed by the phrase “as used in this document shall mean” or similar language (e.g., “this term means,” “this term is defined as,” “for the purposes of this disclosure this term shall mean,” etc.). References to specific examples, use of “i.e.,” use of the word “invention,” etc., are not meant to invoke exception (b) or otherwise restrict the scope of the recited claim terms. Other than situations where exception (b) applies, nothing contained in this document should be considered a disclaimer or disavowal of claim scope.

The subject matter recited in the claims is not coextensive with and should not be interpreted to be coextensive with any embodiment, feature, or combination of features described or illustrated in this document. This is true even if only a single embodiment of the feature or combination of features is illustrated and described in this document.

### INCORPORATION BY REFERENCE

The entire contents of each of the documents listed below are incorporated by reference into this document. If the same term is used in both this document and one or more of the incorporated documents, then it should be interpreted to have the broadest meaning imparted by any one or combination of these sources unless the term has been explicitly defined to have a different meaning in this document. If there is an inconsistency between any of the following documents and this document, then this document shall govern. The incorporated subject matter should not be used to limit or narrow the scope of the explicitly recited or depicted subject matter.
U.S. Pat. No. 7,323,426 (application. Ser. No. 11/026,370), titled “High Strain Point Glasses,” filed on 30 Dec. 2004, issued on 29 Jan. 2008 (the '426 patent).

1. A glass-ceramic having a constituent composition comprising, on an oxide basis: P₂O₅, Al₂O₃, SiO₂, and approximately 3 mol % to approximately 16 mol % of a total amount of one or more modifier oxides, wherein the glass-ceramic comprises cristobalite and is structurally stable.

2. The glass-ceramic of claim 1 wherein the one or more modifier oxides comprise MgO, CaO, ZnO, TiO₂, ZrO₂, and/or SnO₂.

3. The glass-ceramic of claim 1 wherein the one or more modifier oxides comprises ZnO.

4. The glass-ceramic of claim 1 wherein the glass-ceramic comprises gahnite.

5. The glass-ceramic of claim 1 wherein the composition comprises, on an oxide basis: approximately 3 mol % to approximately 12 mol % of P₂O₅, approximately 5 mol % to approximately 30 mol % of Al₂O₃, and approximately 55 mol % to approximately 80 mol % of SiO₂.

6. The glass-ceramic of claim 1 wherein the composition comprises, on an oxide basis: approximately 5 mol % to approximately 8 mol % of P₂O₅, approximately 9 mol % to approximately 20 mol % of Al₂O₃, and approximately 63 mol % to approximately 72 mol % of SiO₂.

7. The glass-ceramic of claim 1 wherein at least 50 vol % of the glass-ceramic is crystalline.

8. The glass-ceramic of claim 1 wherein at least 50 wt % of the glass-ceramic is crystalline.

9. The glass-ceramic of claim 1 wherein at least a majority of the crystallinity in the glass-ceramic is cristobalite.

10. The glass-ceramic of claim 1 wherein at least 35 wt % of the glass-ceramic is cristobalite.

11. The glass-ceramic of claim 1 wherein the glass-ceramic has a coefficient of thermal expansion of at least 10 ppm/° C.

12. The glass-ceramic of claim 1 wherein the glass-ceramic has a coefficient of thermal expansion of at least 25 ppm/° C.

13. The glass-ceramic of claim 1 wherein the glass-ceramic shows no sign of crack formation.

14. The glass-ceramic of claim 1 wherein the glass-ceramic has a glossy surface appearance.

15. A method for making a glass-ceramic comprising:
heating an aluminophosphosilicate glass to facilitate nucleation and form a nucleated glass, the aluminophosphosilicate glass comprising, on an oxide basis: approximately 3 mol % to approximately 16 mol % of a total amount of one or more modifier oxides;
heating the nucleated glass to a higher temperature to facilitate crystallization and form a partially crystallized glass; and
cooling the partially crystallized glass to room temperature without breaking the partially crystallized glass to form the glass-ceramic.

16. The method of claim 15 comprising:
melting a glass composition having the same composition as the aluminophosphosilicate glass to form a glass melt; and
cooling the glass melt to form the aluminophosphosilicate glass.

17. The method of claim 16 wherein the aluminophosphosilicate glass comprises, on an oxide basis: approximately 3 mol % to approximately 12 mol % of P₂O₅, approximately 5 mol % to approximately 30 mol % of Al₂O₃, and approximately 55 mol % to approximately 80 mol % of SiO₂.

18. (canceled)

19. A glass-ceramic formed from an aluminophosphosilicate glass comprising, on an oxide basis: approximately 3 mol % to approximately 20 mol % of a total amount of one or more modifier oxides, wherein the glass-ceramic comprises cristobalite and is structurally stable and wherein the glass-ceramic is free of cracks.

20. The glass-ceramic of claim 19 wherein the aluminophosphosilicate glass comprises, on an oxide basis: approximately 3 mol % to approximately 12 mol % of P₂O₅, approximately 7 mol % to approximately 30 mol % of Al₂O₃, and approximately 55 mol % to approximately 80 mol % of SiO₂.

21. The glass-ceramic of claim 19 wherein the one or more modifier oxides comprises MgO, CaO, ZnO, TiO₂, ZrO₂, and/or SnO₂.
